(19) United States
(12) Patent Application Publication
(10) Pub. No.: US 2008/0288330 A1
(43) Pub. Date: Nov. 20, 2008

(54) SYSTEM AND METHOD FOR USER ACCESS RISK SCORING

(75) Inventors: David Hildebrand, Austin, TX (US); Darran Rolls, Austin, TX (US)

Correspondence Address: SPRINKLE IP LAW GROUP, 1301 W. 25TH STREET, SUITE 408, AUSTIN, TX, 78705, US

(73) Assignee: SailPoint Technologies, Inc., Austin, TX (US)

(21) Appl. No.: 12/120,502

(22) Filed: May 14, 2008

Related U.S. Application Data
(60) Provisional application No. 60/930,144, filed on May 14, 2007.

(51) Int. Cl. G06F 17/30

(52) U.S. Cl. 705/10

(57) ABSTRACT

Systems and methods for measuring access risk associated with an enterprise having at least one resource accessible by at least one user with at least one entitlement to access the resource. Some embodiments implement a method of identifying the resources, users, and entitlements and associating access risk scores with the entitlements. The method can include combining the access risk scores associated with each user to form composite access risks scores and outputting the composite access risk scores. In some embodiments, the user with the highest composite access risk score can be identified and remedial action taken. The highest access risk user of some embodiments may be a department, a division, a subsidiary, or an organization. The method can occur in real time and an administrator can be alerted to changes in entitlements. Access risk scores can be adjusted for compensating controls and personal factors and attributes of the users.

### CROSS-REFERENCE TO RELATED APPLICATIONS

This application claims priority from Provisional Patent Application No. 60/930,144, filed May 14, 2007, entitled “SYSTEM AND METHOD FOR USER ACCESS RISK SCORING,” the content of which is hereby fully incorporated herein for all purposes.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD OF THE DESCRIPTION

Embodiments of the disclosure relate generally to enterprise access risk management and more particularly to measuring access risk associated with information technology (IT) related resources of enterprises.

### BACKGROUND

Acts of fraud, data tampering, privacy breaches, theft of intellectual property, and exposure of trade secrets have become front page news in today's business world. The security access risk posed by insiders—persons who are granted access to information assets—is growing in magnitude, with the power to damage brand reputation, lower profits, and erode market capitalization.

Escalating security and privacy concerns are driving governance, access risk management, and compliance (GRC) to the forefront of identity management. To effectively meet the requirements of GRC, companies may be required to prove that they have strong and consistent controls over who has access to critical applications and data. And, in response to regulatory requirements and the growing security access risk, most companies have implemented some form of user access or identity controls.

Yet many companies still struggle with how to focus compliance efforts to address actual business risk in their IT (information technology) environment. Decisions about which access entitlements are desirable to grant a particular user are typically based on the business roles that the user plays within the organization. In large organizations, granting and maintaining user access entitlements is a difficult and complex process, involving decisions regarding whether to grant entitlements to thousands of users and hundreds of different applications and databases. This complexity can be exacerbated by high employee turnover, reorganizations, and reconfigurations of the various accessible systems and resources.

A 2007 survey on identity compliance conducted by the Ponemon Institute LLC of Kewadin, Mich. and SailPoint Technologies, Inc. of Austin, Tex. revealed that a majority of organizations do not take an access risk-based approach to identity compliance.

Organizations that are unable to focus their identity compliance efforts on areas of greatest access risk can waste time, labor, and other resources applying compliance monitoring and controls across the board to all users and all applications. Furthermore, with no means to establish a baseline measurement of identity compliance, organizations have no way to quantify improvements over time and demonstrate that their identity controls are working and effectively reducing corporate access risk.

IT personnel of large organizations feel that their greatest security risks stemmed from “insider threats,” as opposed to external attacks. The access risks posed by insiders range from careless negligence to more serious cases of financial fraud, corporate espionage, or malicious sabotage of systems and data. Organizations that fail to proactively manage user access can face regulatory fines, litigation penalties, public relations fees, loss of customer trust, and ultimately lost revenue and lower stock valuation. To minimize the security risk posed by insiders, business entities and institutions alike often establish user access policies that eliminate or at least reduce such access risks and implement proactive oversight and management of user access entitlements to ensure compliance with defined policies and other good practices.

### SUMMARY OF THE DESCRIPTION

Embodiments of the present disclosure provide systems and methods for measuring access risk associated with the internal IT related resources of enterprises that eliminate, or at least substantially reduce, the shortcomings of prior art, access risk measuring systems and methods.

Various embodiments relate to information security, role management, identity management, user access, and user access entitlement management. Embodiments implement systems and methods for providing and improving information security and access risk management. Embodiments provide tools for identifying, evaluating, and responding to the access risks associated with user access to sensitive digital resources such as systems, applications, data, etc.

One embodiment implements a method for measuring access risk associated with an enterprise. The enterprise can have resources accessible by users with entitlements to access the resource. The method can include identifying and documenting the resources, the users, and the access entitlements. Access risk scores can be associated with the entitlements. For each user, the access risk scores associated with the user can be combined to form a composite access risk score which can be output.

One embodiment includes a system which can include resources with access points for various users, a processor in communication with the resources, an output, and a machine readable medium in communication with the processor. The machine readable medium can store instructions which can cause the processor to identify the resources, the users, and access entitlements associated with the resources and users. The instructions can also cause the processor to associate access risk scores with the entitlements. The instructions can cause the processor to, for each user, combine the access risk scores associated with the user to form a composite access risk score.

One embodiment includes machine readable medium which can store instructions for assessing access risk for enterprises. The instructions can cause a processor to identify enterprise resources, users, and access entitlements associated with the resources and users. The instructions can also cause the processor to associate access risk scores with the entitlements. The instructions can cause the processor to, for each user, combine the access risk scores associated with the user to form a composite access risk score.

Embodiments provide systems and methods for measuring access risk associated with an enterprise having potentially numerous resources which can be accessible by various users. Some embodiments implement a method of identifying the resources, users, and entitlements and associating access risk scores with the entitlements. The method can include combining the access risk scores associated with each user to form composite access risks scores for the users and outputting the same. The user with the highest composite access risk score can be identified and remedial action taken. The highest access risk user of some embodiments may be a department, a division, a subsidiary, or an organization. The method can occur in real time and an administrator can be alerted to changes in the entitlements. Access risk scores can be adjusted for compensating controls and personal factors of the users. Personal access risk factors can include geographic locations, demographic characteristics of the user, behavior, personal history, a previous entitlement the user had, a previous role the user had, an entitlement that has been disassociated with the user yet recurs, etc.

Various embodiments provide enterprise level systems which include various internal resources with access points for their users. The enterprise level system can include a processor, an output, and a machine readable memory in communication with each other and the internal resources. The machine readable memory can store instructions which when executed cause the processor to identify the internal resources, the users, and the entitlements. The instructions can also cause the processor to associate an access risk score with each of the entitlements and to combine the access risk scores associated with each individual user to form composite access risk scores for the individual users. The processor can output the composite access risk scores at the output. Machine readable medium storing instructions for measuring access risk associated with enterprise resources are provided by various embodiments.

Methods implemented by various embodiments can identify, measure monitor, and eliminate or mitigate access risks and integrate data relevant to access risk into centralized access risk management solutions. Some embodiments provide insight into potential access risk factors across complex enterprises and allow organizations to proactively focus internal controls to reduce potential compliance exposure and liability as well as other disadvantages associated with previously available access risk management approaches. Access risk can be reduced using advanced analytics which measure baseline access risk, the effectiveness of controls in reducing access risk, and combinations thereof.

Embodiments provide numerous advantages over previously available systems and methods for measuring access risk. Systems and methods disclosed herein can provide IT compliance and governance managers and others simple, intuitive means to assess the effectiveness of access controls and the associated access risk across large numbers of users, applications, systems, etc. By increasing the visibility of user access risk at various levels across various resources, organizations can pinpoint at-risk areas and focus their security and access control efforts where such focus may be desired. At-risk areas can be pinpointed by sorting composite access risk scores of individuals, departments, organizations, and the like and listing those access risks which exceed user selected thresholds. Systems and methods disclosed herein can implement compensating controls which can decrease access risk in situations in which an individual, department, organization, or the like exceeds user selected thresholds.

Embodiments can provide baseline snapshots of user access compliance for a business entity or organization at any point in time. Systems and methods disclosed herein can provide organizations with automated controls to lower individual user access risk scores as well as overall corporate access risk profiles. Methods of scoring access risk, disclosed herein, can enable a business enterprise or organization to track progress over time and provide quantifiable proof of enhanced security and reduced access risk. Systems and methods disclosed herein can provide graphical, intuitive performance tracking of high-access risk users and resources (e.g., systems, applications, data, etc.). Embodiments can provide metrics that can be used to justify security enhancement and access risk reduction initiatives. These metrics can serve as proof of access risk levels; improvements thereto; the effects of re-certification efforts on the same; and attempts to identify and eradicate or reduce access risk issues.

Various embodiments provide systems and methods for notifying users of the access risk status of enterprises. An access risk advisor module of some embodiments sends messages, notifications, reports, alerts, alarms, etc. to the users, system administrators, managers, executives, stakeholders, application owners, etc. These notifications can be based on changes in various access risk scores detected in real time according to various embodiments. The access risk advisor module can be configured to escalate these notifications to appropriate personnel if the initial, and subsequent, notified personnel fail to take appropriate remedial action in a timely manner. The access risk advisor modules of some embodiments can be configured to alert users to the desirability of re-certifying users, systems, resources, data, applications, etc. with access risk levels exceeding user selected thresholds. Re-certifications can occur in real time and on demand in some embodiments. The access risk advisor module can be configured to monitor certain users, systems, resources, data, applications, etc. should they exceed a user selected threshold of access risk. The access risk advisor module can be configured to apply mitigating controls in response to access risk scores exceeding user selected thresholds.

Some embodiments define business roles throughout enterprises in a top down manner. Models of various embodiments can reflect the desired operational objectives of the enterprises. Systems and methods disclosed herein can dynamically correlate users and roles in real time, thereby accurately and in a timely fashion associating those roles, the users, and the capabilities the users have. By dynamically correlating users and roles, systems and methods disclosed herein can identify access entitlements associated with an individual beyond those desirable for the individual's role(s).

In various embodiments, enterprises can perform assessments desirable for improving overall security, detecting potential fraud, and assuring sound management, particularly sound financial management. Various embodiments allow for new, in-depth insights into access risk which can enable enterprises to efficiently, effectively, and globally track, analyze, and control user access to IT resources. Access risks can be quickly and easily assessed in some embodiments. Access risk issues can be identified, prioritized, and immediately remediated or mitigated in various embodiments. By conducting user activity monitoring, eliminating policy violation access risks, and periodic certifications, on-demand certification, scheduled certifications, etc., enterprises can lower access risk. Some embodiments provide access risk trending reports that can measure changes in access risk scores over times providing quantifiable proof thereof.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE FIGURES

A more complete understanding of the disclosure and the advantages thereof may be acquired by referring to the following description, taken in conjunction with the accompanying drawings in which like reference numbers generally indicate like features and wherein:

FIG. 1 is a block diagram illustrating one embodiment of an enterprise.

FIG. 2 is a flowchart illustrating one embodiment for implementing an access risk assessment method.

FIG. 3 is a flowchart illustrating one embodiment for implementing an access risk assessment method.

FIG. 4 is a block diagram illustrating one embodiment of an access risk model.

FIG. 5 is a block diagram illustrating one embodiment of an enterprise model.

FIG. 6 is a flowchart illustrating one embodiment for implementing an access risk assessment method.

FIG. 7 is a screenshot illustrating one embodiment of a graphical user interface.

FIG. 8 is a screenshot illustrating one embodiment of a graphical user interface.

FIG. 9 is a block diagram schematically illustrating one embodiment of an access risk assessment system.

FIG. 10 is a screenshot illustrating one embodiment of a graphical user interface.

FIG. 11 is a screenshot illustrating one embodiment of a graphical user interface.

FIG. 12 is a screenshot illustrating one embodiment of a graphical user interface.

FIG. 13 is a screenshot illustrating one embodiment of a graphical user interface.

FIG. 14 is a screenshot illustrating one embodiment of a graphical user interface.

FIG. 15 is a block diagram schematically illustrating one embodiment of an access risk assessment system.

FIG. 16 is a block diagram schematically illustrating one embodiment of an access risk assessment system.

### DETAILED DESCRIPTION

Various embodiments of the disclosure are illustrated in the FIGURES, like numerals being generally used to refer to like and corresponding parts of the various drawings. Embodiments of the disclosure provide systems and methods for measuring access risk associated with the resources of enterprises.

Before discussing specific embodiments, an embodiment of a hardware architecture for implementing certain embodiments is disclosed herein. One embodiment can include a computer communicatively coupled to a network (the Internet in some embodiments). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

The functionalities and processes disclosed herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments, which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

Turning now to various embodiments, historically, security risks associated with user access have been hard to quantify. In large organizations, user access data can be scattered across hundreds of systems and applications and can be difficult to compile, analyze, and present in a manageable format to the persons in position to act on the information. Consequently, most organizations attempt to manage risk in a decentralized manner, focusing on a single application or system at a time.

Such decentralized, one-at-a-time approaches have several drawbacks. With such approaches, managers may not gain enterprise level visibility of access risk across all at-risk resources. Risk management, even within an organization, may be applied sporadically and thus may prove to be insufficient or ineffective in minimizing access risks posed by inside users. Also, when risk management is decentralized, baselines (such as standards, measures, benchmarks, etc.) utilized in assessing risk may vary from department to department, system to system, and application to application even within the same organization. Moreover, previously available approaches can be time consuming, tedious, impracticable, and expensive since conventional risk management processes often consist of manual reviews of user entitlements and access lists. These deficiencies hinder using assess risk as a relative metric.

### Enterprises

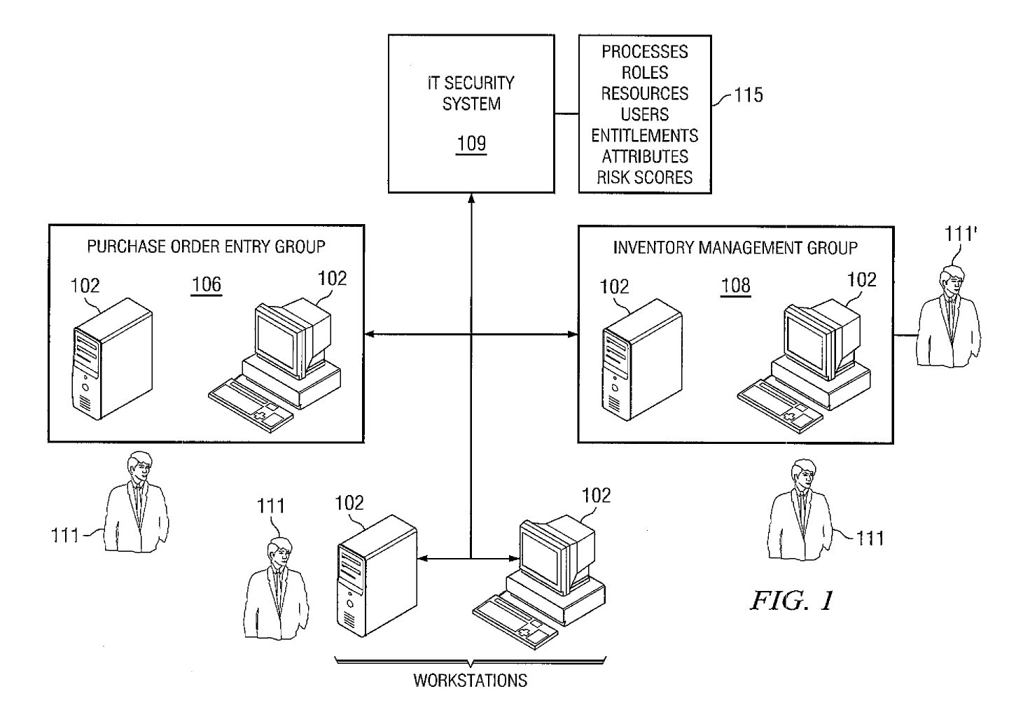

With reference now to FIG. 1, one embodiment of enterprise 100 is illustrated. Enterprise 100 includes a number of resources 102, various resource groups 106 and 108, IT security system 109, and users 111. Users 111 may have various roles, job functions, responsibilities, etc. to perform within various processes associated with enterprise 100. To accomplish their responsibilities, users 111 may have entitlements to access resources 102 which may give rise to risk of negligent or malicious use of resources 102. IT security system 109 may monitor and control users' 111 access to resources 102 and their activities associated with resources 102.

Users 111 can include employees, supervisors, managers, IT personnel, vendors, suppliers, customers, etc. of enterprise 100. Users 111 may access resources 102 to perform functions associated with their jobs, obtain information about enterprise 100 and its products, services, and resources, enter or manipulate information regarding the same, monitor activity in enterprise 100, order supplies and services for enterprise 100, manage inventory, generate financial analyses and reports, etc.

To accomplish different functions, different users 111 may have differing access entitlements to differing resources 102. Some access entitlements may allow particular users 111 to obtain, enter, manipulate, etc. information in resources 102 which may be relatively innocuous. Some access entitlements may allow particular users 111 to manipulate information in resources 102 which might be relatively sensitive. Some sensitive information can include human resource files, financial records, marketing plans, intellectual property files, etc. Access to sensitive information can allow negligent or malicious activities to harm enterprise 100. Access to particular types of information, when combined with access to other particular types of information can allow negligent or malicious activities to harm enterprise 100. In one scenario, a particular user 111 may, if given access to purchase order entry group of resources 106 and to inventory management group of resources 108, might manipulate information therein to conceal negligence, theft, embezzlement, etc. occurring within the purchasing and inventory control departments of enterprise 100.

Access risks can result from a user having entitlements with which the user can access resources 102 that the particular user should not have access to; gain access to another user's negligently protected entitlements; etc. Access risks can arise from roles in enterprise 100 which may shift, change, evolve, etc. leaving entitlements non optimally distributed among various users. Relationships between various roles in enterprise 100 may also give rise to access risk. Where such access risks might arise, policies can be formulated to control such access risks. For instance, some roles, functions, resources, etc. may be incompatible such as 1) the roles of accountant and auditor or 2) purchase order entry and inventory management resource groups 106 and 108. Rules for detecting incompatible roles being assigned to a particular user can be implemented. By examining users' entitlement sets, roles assigned to various users 111 can be determined and compared to each other according to the policy rules. When particular users have incompatible roles, or roles which violate other policies, access risks can be detected and evaluated

Enterprise 100 can also implement various access risk related compensating controls. Compensating controls can be policies, procedures, actions, steps, security features, which enterprise 100 can implement to control, limit, minimize, etc. various access risks. Compensating controls can include completing access certifications, revoking improper and questionable access entitlements, monitoring access activity, monitoring access entitlements (particularly for entitlement changes), etc. Access related certifications could eliminate or reduce access risks although as access certifications age, certification aging access risks 113 may arise. Access risks and the affects of compensating controls can be identified, measured, reported, and corrected. IT security system 109 can include model 115 which can characterize resources 102, groups of resources 106 and 108, users 111, related entitlements, related access risk and compensating controls, etc. of enterprise 100.

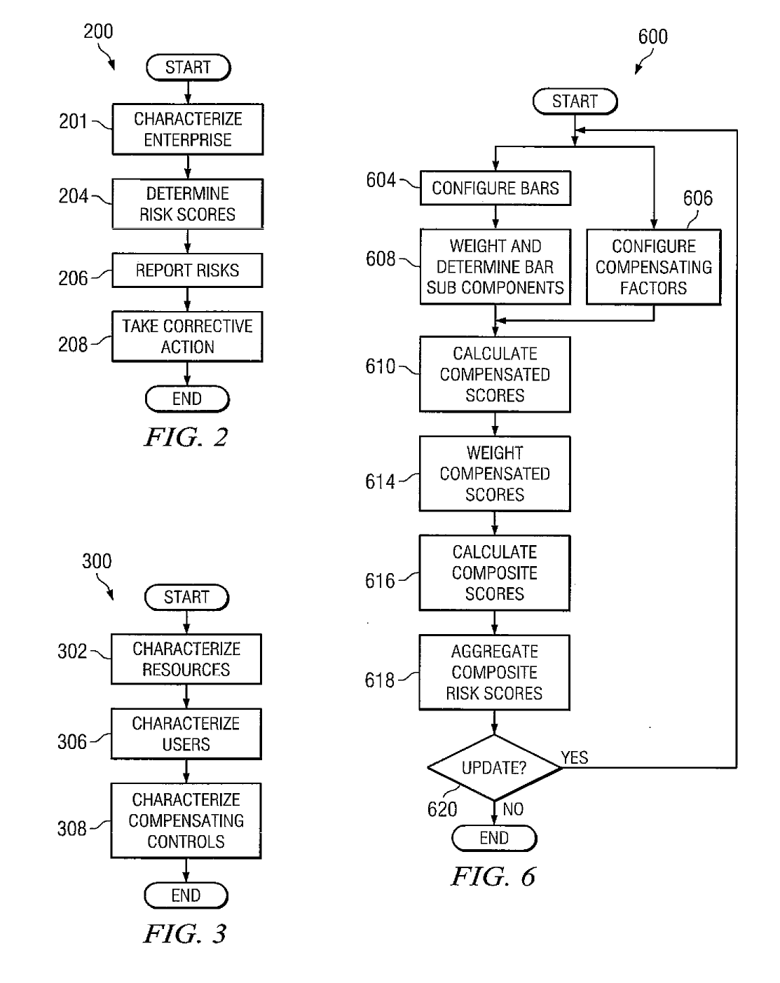

Access risks associated with various aspects of enterprise 100 can be characterized and assessed. Various risk scores such as baseline access risk (BAR) scores, compensating access risk factor (CARF) scores, and composite access risk scores (CARS) associated with access entitlements of various users 111 and groups of users 111 can be determined. Methods for determining various access risk related scores are further disclosed herein with reference to FIGS. 2, 3, and 6. BAR and CARF scores can be derived from sets of various subcomponents. A particular BAR subcomponent can relate to a particular aspect of a particular entitlement which a particular user 111 may have to access a particular resource 102. A particular CARF score can relate to a particular compensating control which enterprise 100 may have implemented to limit, control, contain, etc. a particular access risk associated with a particular user 111. A CARS score for a particular user 111 can be derived from BAR and CARF scores for that user 111 and can indicate overall access risk associated with that user 111.

In determining a CARS score for a particular user 111, selected users 111′ (such as IT personnel, supervisors, managers, etc.) can weight various BAR and CARF subcomponents to indicate the degree to which some subcomponents can contribute to a CARS score for users 111. BAR subcomponents, CARF subcomponents, BAR scores, CARF scores, CARS scores, etc. can be combined for selected groups of users 111.

### Characterization of Enterprises

With reference now to FIG. 2, FIG. 2 illustrates one embodiment implementing method 200. Method 200 illustrates that access risk related features of enterprise 100 can be characterized at step 201 (as discussed further with reference to FIG. 3). At step 204 access risk scores for various users 111 can be determined (as discussed further with reference to FIG. 6). In step 206, access risk scores can be reported to various users 111′ such as IT personnel, supervisors, manager, external systems etc. Step 206 can include combining particular users' access risk scores to determine access risk scores for groups of users such as departments, subsidiaries, etc. of enterprise 100. Corrective action may be taken if any risk scores exceed user selected thresholds at step 208.

Now with reference to FIG. 3, FIG. 3 illustrates one embodiment implementing method 300 for characterizing aspects of enterprise 100. More particularly, method 300 can characterize aspects of enterprise 100 related to resources 102, users 111, access entitlements, and compensating factors. Method 300 can work in conjunction with method 600 of FIG. 6 which can use characterizations developed in method 300 to determine various access risk related scores.

### Characterization of Resources

Among other aspects of enterprise 100, resources 102 can be characterized in step 302 of FIG. 3. Step 302 can include identifying resources 102, determining capabilities, vulnerabilities, etc. of resources 102 related to access risk. Access entitlements to resources 102 can also be identified at step 302. Resources 102 can have differing levels of access risk associated with them. In one scenario, a securities trading application might be considered to have a relatively high access risk. A relatively high access risk value can be set for such resources 102. Access risk levels associated with resources 102 can be associated with any users 111 with access entitlements to such resources 102 and by attestation can effect BAR, CARF and CARS scoring.

Resources 102 can have associated metadata defining various access related attributes. Some attributes can determine which particular users 111 can access particular resources 102 regardless of entitlements which might (not) have been granted to users 111. One difference that can exist between entitlements and attributes can be that an entitlement can designate that a particular user 111 has access to a particular resource 102. An attribute, though, can determine whether particular users 111 have access to particular resources 102 whether or not they have a particular access entitlement for those particular resources 102. Users 111 with a particular value of the attribute can have access to resource 102. Users without that particular value of the attribute can be denied access to resource 102. In some scenarios, telephone area codes can be an attribute such that if particular users 111 have a certain area code, those users can be granted access to some resource 102. In step 302, therefore, access risks arising from features of resources 102 (such as the nature of resources 102, granted entitlements, and associated attributes) can be characterized and appropriate levels of risk set for each resource 102.

Orphaned accounts, system accounts and privileged user accounts can also influence access risks associated with resources 102. It is some times the case that resource 102 might have an associated number of access entitlements associated with it. Some of these access entitlements can be orphaned as the user population and IT environment (among other factors) change. Access risk levels associated with orphaned access entitlements can be assessed and associated with resources 102 at step 302.

### Characterization of Users

At step 306, access risks associated with users 111 can be identified and assessed. Access risk associated with users 111 can be characterized by considering roles, entitlements, attribute values, and policies associated with users 111. Access risk for each of these aspects associated with users 111 can vary depending on the consequences of potential negligent or malicious activity by user 111. In some scenarios, relatively high access risk level for particular aspects of users 111 (such as a role enabling users 111 to delete particular auditable data trails) can be set. Setting high access risk levels can enable close tracking of particular access risks.

Characterizing access risks of users 111 at step 306 can include considering roles held by users 111. Roles can be associated with logical collections of access entitlements according to enterprise 100 related needs, functions, desires, etc. Thus, roles can be viewed as a pattern or set of entitlements. Access risk can therefore be assessed for access entitlements associated with various roles. In some embodiments, access risk can be assessed against the roles themselves. Access risk levels for various roles can be assessed and associated with users 111 having those roles at step 306.

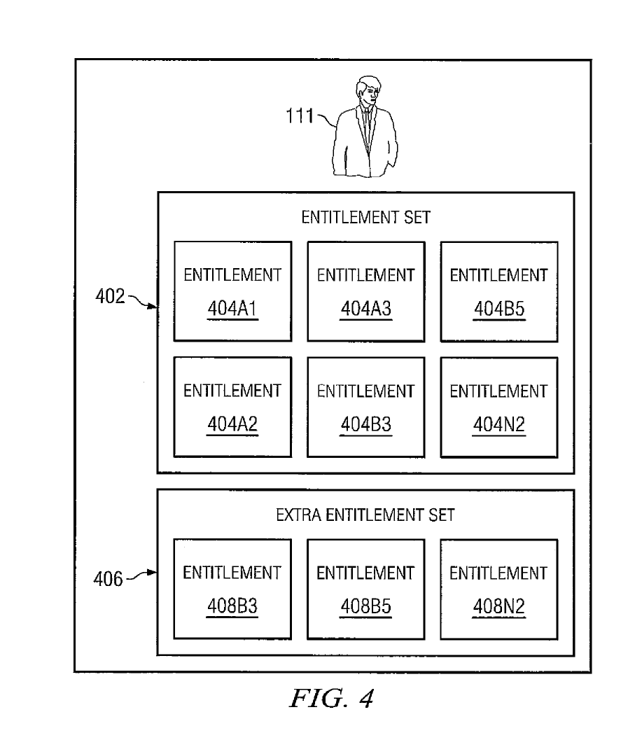

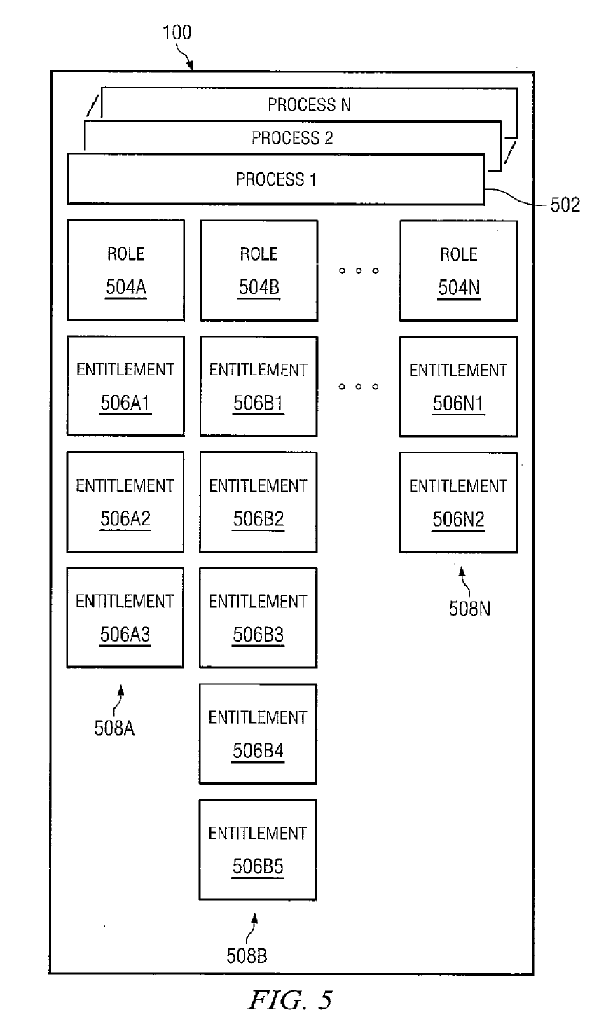

Step 306 can include ongoing monitoring of enterprise 100 to discover changes in the population of users 111, associated attributes, and associated entitlements. The monitoring can be continuous, periodic, in real-time, on demand, scheduled, etc. User attribute and entitlement discovery (hereinafter “user discovery”) can include extracting lists of users 111 attributes and entitlements which have been granted to users 111 to various resources 102 of enterprise 100. With reference now to FIG. 4, for each user 111, user discovery can result in current entitlement and attribute sets 402 and 406 associated with users 111. Data and changes related to users 111 and associated entitlements can be examined to determine each user's business roles. In one scenario illustrated by FIG. 4, it can be determined that a particular user 111 has entitlement set 402 including entitlements 404A1, 404A2, 404A3, 404b2, 404b5, and 404n2. In the current scenario, user 111 has extra entitlement set 406 which can include extra entitlements 408B3, 408B5, and 408N2 (to be discussed with reference to FIG. 5). By separating entitlements in this way this and other embodiments simplify the recognition, attestation and assessment of entitlements.

As shown in FIG. 5, enterprise 100 can include numerous processes 502 each of which can have numerous roles 504 associated therewith. Roles 504 can have one or more entitlements 506 associated therewith. Roles 504 and entitlements 506 can support processes 502. Various embodiments provide tools for defining entitlement filters 508 associated with roles 504. Entitlements 506 (of FIG. 5) associated with user 111 who performs a role 504 of interest with regard to process 502 and who may be selected as a prototypical user such that entitlements 506 desirable for performing role 504 can be mined from enterprise 100. Using the name of the prototypical user, current entitlements 404 for that user 111 can be mined from process 502, resources 102 associated with process 502, etc. Mined entitlements 506 can be added to entitlement filter 508 for role 504. Some embodiments allow roles 504 entitlements 506, etc to be mapped from certain available applications such as Oracle SAP, ERP, etc. to model 115. In some embodiments, users 111 can determine which of the prototypical user's entitlements 506 should be included in entitlement filter 508. Some embodiments provide other methods of creating entitlement filters 508 including manually defining entitlement filters 508.

At step 306 user entitlement sets 402 and entitlement filters 508 (of FIG. 5) can be compared. When a match is found between a portion of a particular user entitlement set 402 (of FIG. 4) and a particular entitlement filter 508, the associated user 111 can be deemed to have the particular role 504. In one scenario (illustrated by FIGS. 4 and 5), user 111 can match entitlement filter 508A for role 504A. In some embodiments, users 111 can match as many roles 504 as portions of their entitlement set 402 match. In some embodiments, the number of roles 504 users 111 can have can be limited.

When user 111 has a particular entitlement 408 that fails to correspond to any entitlement 506 associated with any role 504, unmatched entitlement 408 can be deemed an “extra entitlement.” Extra entitlements 408 for individual users 111 can be grouped together in set 406 of extra entitlements 408. In the current scenario, it can be determined that user 111 has extra entitlements 408B3, 408B5, and 408N2 in extra entitlement set 406.

User entitlement sets 402 and 408 and entitlement filters 508 can be matched using fuzzy logic in which close matches result in user 111 being deemed to have a particular role 504. A fuzzy match can occur when a particular entitlement set 402 matches at least a user selected portion of a particular entitlement filter 508. In some embodiments, the user selected portion of particular entitlement filter 508 includes a majority of entitlements 506 therein. Some embodiments implement configurable fuzzy matching in which users can configure thresholds against which entitlement sets 402 can be deemed to match entitlement filter 508. When the threshold is higher, closer correlation between a particular entitlement set 402 and a particular entitlement filter 508 can result in a match. When the threshold is lower, less precise correlation between a particular entitlement set 404 and a particular entitlement filter 508 can result in a fuzzy match. Users can configure different thresholds for different roles 504, entitlements 506, entitlement filters 508, entitlement sets 402, etc. In one scenario, a particular entitlement filter 508 can include two entitlements 506 of which, one grants greater access to users 111 having that entitlement. In the current scenario, the entitlement 506 granting greater access might have a threshold configured higher than the other entitlement 506. In one scenario, role 504B of FIG. 5 was configured with a matching threshold of 40%. Because user 111 of FIG. 4 has 40% (2 of 5) of entitlements 404 corresponding to role 504B, it can be determined that user 111 is a fuzzy match with role 504B. If role 504B was configured with a matching threshold greater than 40%, it could be determined that user 111 is not a fuzzy match with role 504B.

Weightings may be associated with user entitlements 404 to be matched with entitlement filters 508. At step 306, it can be determined whether the combined weight associated with a particular user 111 and a particular entitlement filter 508 exceeds the fuzzy matching threshold for the particular role 504. In one scenario, entitlements 506 of entitlement filter 508b entitlements are weighted as follows:

| | | |
|---|---|---|
| Entitlement 506B1 | 10% | |
| Entitlement 506B2 | 5% | |
| Entitlement 506B3 | 45% | Matched by user 111 |
| Entitlement 506B4 | 10% | |
| Entitlement 506B5 | 30% | Matched by user 111 |

User 111 with entitlements corresponding to entitlements 504B3 and 504B5 (of FIG. 5), in the current scenario, can have a combined weight of 75%. If the matching threshold associated with entitlement filter 508B is set to 65%, then user 111 exceeds the matching threshold and can be deemed to have a weighted fuzzy match with role 504B.

Entitlement sets 402 of users 111 associated with fuzzy matches can be modified by granting to users 111 entitlements 506 which would cause the fuzzy matches to become exact matches. In some embodiments, which entitlements 506 to grant to particular users 111 to cause fuzzy matches to become exact matches can be determined. Users 111 can be granted entitlements 506B1, 506B2, and 506B4 to complete their entitlement sets 402 with regard to entitlement filter 508. In some embodiments, IT security system 109 notifies a user such as a manager, system administrator, etc. of the possible desirability of granting entitlements 506 to user 111 in order to comply with the entitlement allocation defined by role 504.

Information from efforts to match users 111 to roles can be used to initiate changes to roles, granted entitlements, etc. In one scenario, when a large number of users 111 have a large number (but not all) of entitlements 506 associated with a particular role 504 this condition can indicate that the particular role 504 may have been defined to restrictively. Role 504 may then be modified or various users 111 may be granted the missing entitlements.

Characterizing access risk associated with users 111 at step 306 can also include considering policies applicable to users 111. Policies can be implemented to indicate which users 111 can perform various functions, which users 111 may not be allowed to perform certain functions, etc. One type of policy which is often implemented includes separation of duties policies. Some separation of duty policies indicate that certain functions, roles, etc. should be performed by differing users 111. Separation of duty policies can illustrate how access risk associated with users 111 can be characterized by considering policies. If a particular policy violation (such as a user 111 with entitlements to access purchase order entry resource group 106 is discovered as having entitlements to access inventory management resources group 108) is detected, an access risk level can be set for the particular policy (or violation) and can be associated with users 111 at step 306.

Various entitlements, attributes, and roles can be mapped to associated users 111 to create an identity within enterprise 100. Access risks associated with such identities can also be characterized at step 306.

### Characterization of Compensating Controls

The effects of compensating controls can be characterized at step 308 of FIG. 3. Compensating controls can be procedures, security features, etc. which enterprise 100 may have implemented to manage various access risks. Some compensating controls can be implemented to compensate for access risks related to a particular user 111, entitlement, role, resource, etc. Some compensating controls can apply to combinations of user 111, entitlement, role, resource, etc. Compensating controls often reduce access risk. Some times, however, compensating controls can increase access risk such as when a particular compensating control begins to age. Reductions (or increases) to access risk associated with compensating controls can be characterized at step 308. Adjustments to various access risks reflecting various compensating controls can be termed compensating factors. At step 308 levels for various compensating factors can be assessed and associated with various access risks as discussed with reference to steps 302, 304, and 306.

One type of compensating control can be certification of various aspects of access risks. Certification can include a process of having a designated user 111′ (such as a manager, system administrator, resource owner, etc.) review access risks associated with particular users 111, resources 102, entitlements, attributes, etc. Certification can therefore lower access risks associated with such aspects of enterprise 100. Certification (or recertification) can be triggered by identities, users 111, resources 102, etc. with overall access risk exceeding some user selected threshold. Certification (and recertification) of access risks can occur on a proactive, scheduled, periodic, on demand, random, etc. bases. Since certification can be a dynamic, ongoing process, certification dates can be monitored such that if a certification becomes older than some threshold, access risk may be raised for subjects of the certification.

Another compensating control can be revocation of entitlements. Revocation may occur directly or indirectly by notification of an appropriate manager, administrator, etc. that a revocation might be called for. When an entitlement is revoked, access risk may be re-assessed, thereby accounting for the associated access risk reduction. Extra entitlements 508 can be revoked accordingly to reduce access risk.

Another compensating control, which can be implemented to mitigate access risk, can be implementation of activity monitoring. Activity monitoring can occur at various logs, system control points, etc when access risks associated with some subject exceeds a user selected threshold. Data gathered during activity monitoring can be stored for compliance review, analysis, etc. At step 308, compensating factor levels can be assessed for various compensating controls and associated with applicable subjects identified in steps 302 and 306.

### Calculating Risk Scores

Now with reference to FIG. 6, access risk scores can be determined based on access risk related information and compensating factors which can measure the effectiveness of compensating controls associated with mitigating or eliminating access risk. Some access risks and compensating factors can be given weights which may correspond to their effect on overall access risk. To allow for customization of access risk calculations, organizations can customize compensating factor weights to emphasize which access risks and compensating factors play roles of differing significance in determining overall access risk.

FIG. 6 is a flowchart illustrating method 600 implemented by various embodiments for measuring access risk associated with resources of various enterprises 100 (see FIG. 1). Some embodiments can use three types of scores to measure access risk: baseline access risk (BAR) scores, compensating access risk factor (CARF) scores, and composite access risk scores (CARS). BAR scores can measure access risk associated with users' roles 506 and associated access entitlements 404. CARS scores can be derived by applying CARF scores to BAR scores.

Steps 604 and 606, respectively, illustrate that various BAR and CARF subcomponents can be configured. Step 604 allows BAR scores to be characterized using a number of access risk subcomponents. BAR scores can characterize the access risk level associated with allowing a particular user 111 access to one or more resources 102 of enterprise 100. BAR subcomponents of some embodiments can reflect: access risk inherent in role(s) 504 or job function(s) of user 111, access risk inherent in extra entitlement set 406 of user 111, and access risk of user 111 violating various policies.

BAR subcomponent scores can be determined using data mined from the IT environment of enterprise 100. Job function access risk can be determined by roles 504 that user 111 plays within enterprise 100 based on access entitlements 506 associated with those roles 504. Entitlement access risk can be determined by the number and type of access entitlements 408 held by user 111 that do not map to roles 504 or to job functions held by user 111 (extra entitlements). Policy violation risk can be determined by the number and type of policy violations detected for a particular user 111.

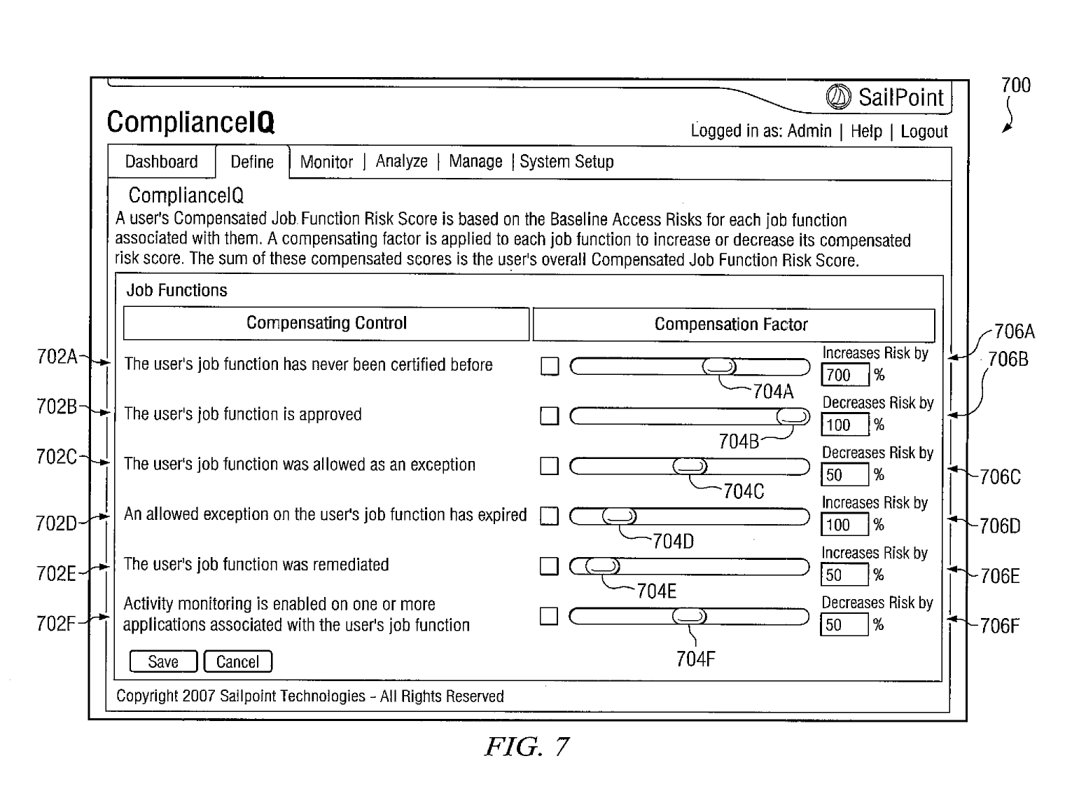

Using graphical slider bars of graphical user interfaces (GUIs) provided by some embodiments, in step 608, users 111′ can customize the weightings for each BAR subcomponent. FIG. 7 illustrates GUI screen 700 for setting such weightings of some embodiments. Screen 700 can display various BAR subcomponents 702 and corresponding slider bars 704 and weightings 706. Authorized users 111′ can access screen 700 and move slider bars 704 to adjust weightings 706 for various BAR subcomponents 702. Weightings 706 can be in terms of percentage, fractions, etc. In one embodiment, weightings 706 can be in a range from zero to 1000 with higher scores indicating higher levels of access risk.

With reference again to step 604 of FIG. 6, BAR subcomponents can be added to and deleted from consideration as enterprise 100 changes and according to users' 111 desires, thereby making method 600 extensible with respect to BAR and with respect to the desires of differing enterprises 100. In some embodiments, the top-level BAR score can be determined by averaging, adding, combining, etc. BAR subcomponents 702 at step 608. With regard to various BAR subcomponents 702, embodiments allow the level of access risk to be characterized for each business role 504, extra entitlement 508, and policy violation risk associated with user 111.

With continuing reference to FIG. 6, step 606 allows various CARF subcomponents to be characterized. CARF subcomponents can correspond, in some embodiments, to compensating controls which can be steps, policies, actions, etc. taken to manage aspects of access risk. CARF subcomponents can measure, gauge, quantify, etc. the effectiveness (either positive or negative) of compensating controls. In various embodiments, each BAR subcomponent can have no, one, or more CARF subcomponents associated therewith. CARF subcomponents of some embodiments can include subcomponents for role(s) 504 or job function(s) of users 111, subcomponents for extra entitlement set 406, subcomponents for policy violation risks, and subcomponents for certification aging. CARF subcomponents can be added to and deleted from consideration as enterprise 100 changes and according to users' 111′ desires, thereby making IT security system 109 extensible with respect to CARF subcomponents and with respect to the desires of differing enterprises 100.

With continuing reference to step 606, various CARF subcomponents which reduce or increase BAR scores can be configured. Role 504 CARF subcomponents can include subcomponents which can:

Increase role BAR score if role 4F04 has not undergone access certification or failed certification.
Decrease role BAR score if role 4F04 successfully underwent access certification.
Decrease role BAR score if role 4F04 was allowed as an exception during access certification.
Increase role BAR score if role 4F04 if an allowed exception associated with role 4F04 has expired.
Increase role BAR score if role 4F04 was designated for removal during access certification (or any other time) but role 4F04 persists or recurs.

Extra entitlement 508 CARF subcomponents can include subcomponents which can:

Increase extra entitlement BAR score if extra entitlement 508 has not undergone access certification.
Decrease extra entitlement BAR score if extra entitlement 508 successfully underwent access certification.
Decrease extra entitlement BAR score if extra entitlement 508 was allowed as an exception during access certification.
Increase extra entitlement BAR score if an allowed exception associated with extra entitlement 506 has expired.
Increase extra entitlement BAR score if extra entitlement 508 was designated for removal during access certification (or at any other time) but extra entitlement 506 persists or recurs.

In some embodiments, policy violation risks can require that some tasks be separated into disjointed subtasks to be performed by different users 111 with mutually exclusive roles 504. Some policies arise to prevent fraud, conflicts of interest, protection of fiduciary duties, etc. Policies can define a set of rules which can correspond to potential separation of duty (SOD) violations. If a particular user 111 happens to have roles 504 or entitlements 404 or 408 allowing that user 111 to perform two or more tasks which must be disjointed to comply with a SOD policy rule, a SOD violation can be said to exist or, at least, that an access risk of a SOD violation exists. Policy CARF subcomponents can include subcomponents which can:

Increase the SOD policy BAR score if the SOD violation has not undergone access certification.
Decrease the SOD policy BAR score if the SOD violation successfully underwent access certification.
Decrease the SOD policy BAR score if the SOD violation was allowed as an exception during access certification.
Increase the SOD policy BAR score if an allowed exception associated with a SOD policy has expired.

With reference still to step 606, another compensating factor can account for the time, which may have passed since aspects of enterprise 100 underwent access certification. As access certifications age, access risk grows such that aspects of access to resources of enterprise 100 might no longer be optimal. As access certifications age, confidence in the accuracy of the certifications can degrade accordingly. In some embodiments, certification aging CARF subcomponents can increase a BAR score which last underwent access certification longer than some user selectable time ago. In one scenario, 30 days elapses after the sign-off of an access certification before the certification CARF subcomponents begins increasing the BAR score. Certification aging CARF subcomponents can continue increasing the associated BAR score for as long as no new access certification occurs or until some user selected maximum BAR increase occurs. Various certification aging CARF subcomponents can include subcomponents which can:

Increase an appropriate BAR subcomponent if access certification has aged beyond a user selected threshold.
Decrease an appropriate BAR subcomponent if access certification has occurred within a user selected threshold.
Decrease an appropriate BAR subcomponent if a particular role 4F04 was disallowed during access certification.
Decrease an appropriate BAR subcomponent if activity monitoring is occurring for particular users, resources, etc.

In some embodiments activity monitoring may also capture auditable logs of user activity and can serve as a compensating control with an associated CARF subcomponents.

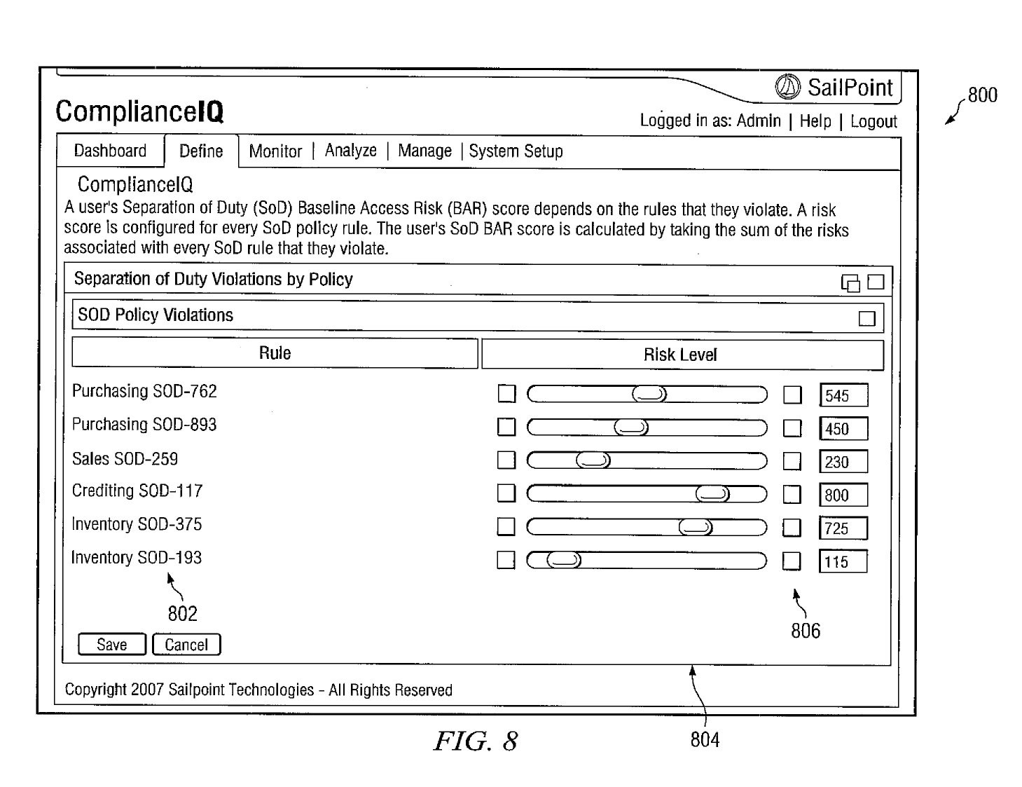

Using graphical slider bars of graphical user interfaces (GUIs) users 111′ can customize the weightings for each BAR score, CARF score, and subcomponents thereof in step 608. FIG. 8 illustrates such a GUI screen 800 of some embodiments. Screen 800 can display various BAR scores, compensating factors, and subcomponents thereof 802, and corresponding slider bars 804 and weightings 806. Users can access screen 800 and move slider bars 804 to adjust weightings 806 for various subcomponents 802. Weightings 806 can be in terms of ranges, fractions, etc. In one embodiment, weightings 806 can be in a range of percentages from zero to 1000.

With reference to FIG. 6 again, at step 608, overall BAR scores for various users can be calculated. Role, extra entitlement, and policy BAR subcomponents can be determined and added together, or otherwise combined, to yield the overall BAR for individual users 111. Applicable CARF subcomponents may be applied to the BAR scores to yield CARS scores corresponding to various users 111 at step 610. CARF subcomponents for individual users can be determined by comparing the status of roles 504, extra entitlements 408, and policy violations associated with individual users 111 and the age of the last access certification of each aspect of individual users 111. Various CARF subcomponents can then be applied to the appropriate BAR subcomponents. In some embodiments, CARF subcomponents can be combined for various individual users 111 with the corresponding BAR scores to form compensated BAR subcomponents corresponding to users 111. Compensated BAR subcomponents can represent access risks for corresponding users 111. User access data as well as the effects of compensating controls can be factored into the compensated BAR subcomponents scores as shown by method 600. In some embodiments, compensated BAR subcomponents scores can be summary scores used for reporting access risk on a user-by-user basis.

Still with reference to FIG. 6, at step 614, user selected weightings may be applied to compensated BAR subcomponents. Weights 706 can indicate the degree to which compensated BAR subcomponents contribute to overall CARS scores. In some embodiments, the weighted, and compensated BAR subcomponents can be added together or otherwise combined at step 616 to yield composite access risk scores (CARS scores) for individual users 111.

At step 618, users 111 can select a population of users 111 of interest. Individual users' BAR scores, compensated BAR scores, CARS scores, subcomponents thereof, and various combinations, may be combined to create scores for departments, geographic groupings of users, functional groupings of users, the entire enterprise, etc. In some embodiments, such aggregate scores can reflect an average of the corresponding users' scores, a cumulative combination of the corresponding users' scores, etc.

Step 620 shows that method 600 of FIG. 6 can be repeated continuously, periodically, on demand, or as frequently as desired or scheduled. Circumstances, changes to enterprise 100, the frequency with which users entitlements change, and other events can be pertinent to how often method 600 updates enterprise's 100 access risk assessment. In one embodiment, user discovery and access risk assessment may be performed daily during high employee turnover periods (such as holiday periods) to account for potentially increased access risks during such periods. In some embodiments, resources (with which large consequences may be associated if negligent or malicious access occurs such as a general ledger system) might have a stable population of users thereby allowing user discovery and access risk assessment to be performed on a relatively less frequent bases such as quarterly.

### It Security System Architecture

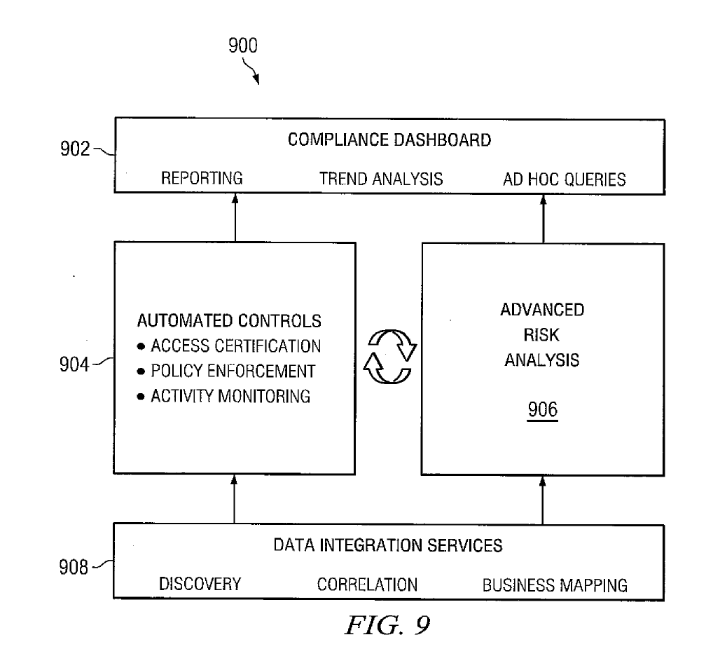

With reference now to FIG. 9, FIG. 9 illustrates a block diagram of access risk management system 900 of some embodiments. System 900 can include several modules 902, 904, 906, and 908. Compliance dashboard module 908 can provide a centralized console or graphic user interface (GUI) for managing and reporting on access risk and related metrics (BAR scores, CARF scores, CARS scores, etc.) across enterprise 100 of FIG. 1.

Automated controls module 904 can allow organizations to establish consistent, repeatable, internal controls to assist in the mitigation and elimination of access risk. These automated controls can include 1) access certifications such as periodic reviews and approvals of access entitlements, 2) policy enforcement, which can detect, correct, and prevent access policy violations, 3) activity monitors, and 4) activity reports related to high-access risk users and resources as well as other subjects of interest across enterprise 100.

As shown in FIG. 9, access risk analytics module 906 can enable organizations to filter, sort, analyze, interpret, evaluate, etc. access risk related data based on access related data. Access risk analytics module 906 can enable organizations to filter, sort, analyze, interpret, evaluate, etc. data related to the effectiveness of controls implemented to mitigate or eliminate access risks. In some embodiments, access risk analytics module 906 can enable organizations to filter, sort, analyze, interpret, evaluate, etc. access risk to improve the effectiveness of access risk controls, the security and compliance of enterprise 100.

Data integration module 908 can discover and correlate users, configuration data pertaining to access entitlements, and user activity data from disparate user accounts, log files, and other data sources, into single, logical representations associated with various users and groupings thereof. In some embodiments, data integration module 908 can use pattern-matching technology to map entitlement data into predefined roles or job functions. Data integration module 908, of some embodiments can transform disparate IT data into centralized information which can be used to proactively manage access risk.

Dashboard module 902 can provide users customizable screens for non-technical users, IT users, etc. Dashboard module 902 can show at-a-glance charts and graphs and provide users the ability to examine related source data. Dashboard module 902 can be an access risk management tool for a variety of users including managers, executives, and compliance and IT staff. In some embodiments, dashboard module 902 can:
Display intuitive, graphical profiles of enterprise access risk across even large numbers of users and applications.
Pinpoint at-risk areas, enabling organizations to focus security and access control efforts where they might be desired.
Enable queries initiated from summary charts and graphs pertaining to, or derived from, source data as well as summaries, query results, reports, etc.
Track progress and provide measurable proof of enhanced security and reduced access risk to enterprise 100.

Dashboard module 902 (of FIG. 9), of some embodiments, enables user to take remedial action to mitigate or eliminate access risk during management reviews, access certifications, etc. for single users, groups of users, departments, etc. Dashboard module 902 can provide GUI screens, or elements thereof, for users to initiate on-demand access certifications for given users, departments, etc. In response, dashboard module 902 can cause reports of user access entitlements, compensating factors, policy violations and access risks, etc. to be generated and sent to pre-selected reviewers. In some embodiments, dashboard module 902 can provide users tools to address policy violations, remediate access entitlements, allow exceptions, etc. Dashboard module 902 can provide features to allow users to activate monitoring of particular user's activities as desired. When a user activates monitoring, dashboard module 902 can cause the affected users' activities to be logged and reports derived there from to be routed to pre-selected reviewers such as management personnel, via email or connections to other external systems, etc.

Various embodiments provide suites of tools for measuring and tracking access risk. Access risk analytics module 906 can be used to establish baseline access risk assessments of a current state of enterprise compliance with access risk policies, standards, requirements, regulations, etc. Baseline access risk assessments can identify users, resources, applications, systems, groups, departments, etc. with various access risk levels. Dashboard module 902 can allow users to track access risk changes over time and provide measurable proof of enhanced security, lowered access risk, etc.

### Graphical User Interface for Access Risk Assessment

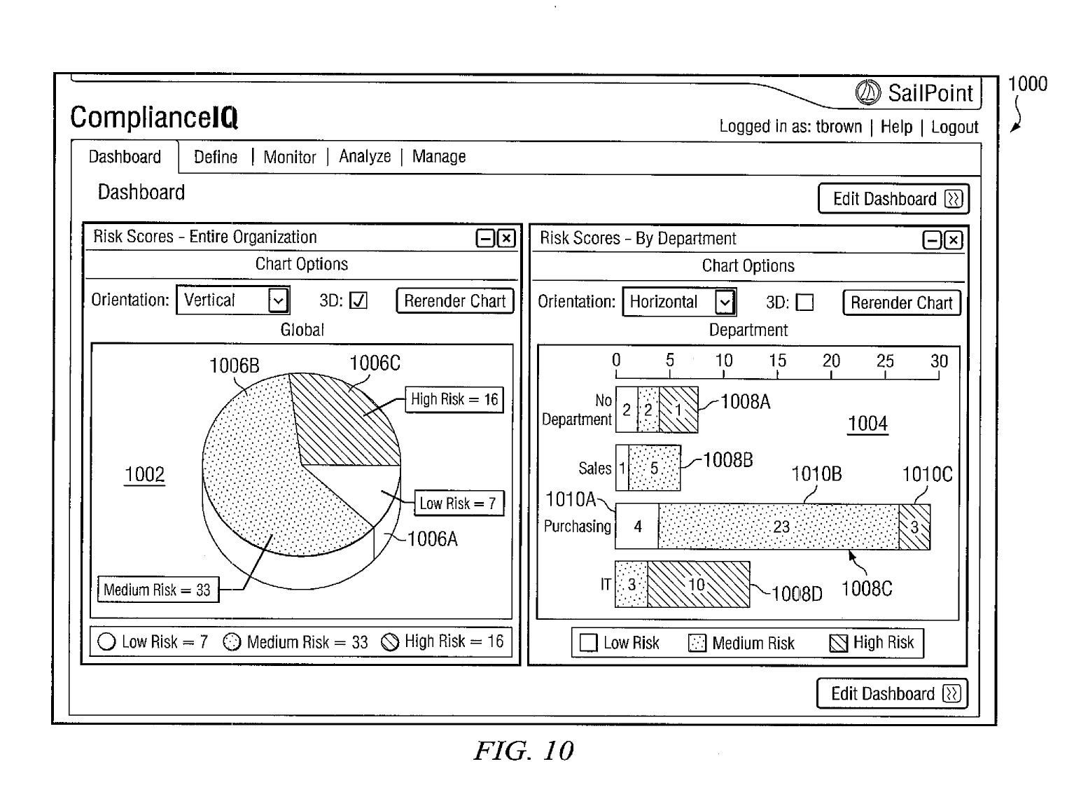

FIG. 10 illustrates GUI screen 1000 of various embodiments. Data displayed in FIG. 10 can provide managers, compliance personnel, etc. with a graphical “heat map” of at-risk areas, thereby allowing users to pinpoint at-risk users, applications or departments, groups etc. Screen 1000 can include various displays such as pie chart 1002 and bar chart 1004. Pie chart 1002 of some embodiments shows a global view of all enterprise users sorted by access risk severity. Within pie chart 1002, sectors 1006A-C show that in one scenario there are 7 low access risk users, 33 medium access risk users, and 16 high access risk users in an organization, respectfully. Bar chart 1004 shows breakdowns of access risk by departments. In one scenario, bar chart 1004 shows bars 1008A-D for various departments illustrating the number of users having various access risk levels. In the current scenario, bar 1008C shows that the purchasing department has 4 low access risk users, 23 medium access risk users, and 3 high access risk users via bar segments 1010A-C respectively. By perusing departmental based bar chart 1004 a user can quickly determine, via selecting bar 1008D, that the IT department (with 10 high access risk users) represents the highest access risk organization within enterprise 100.

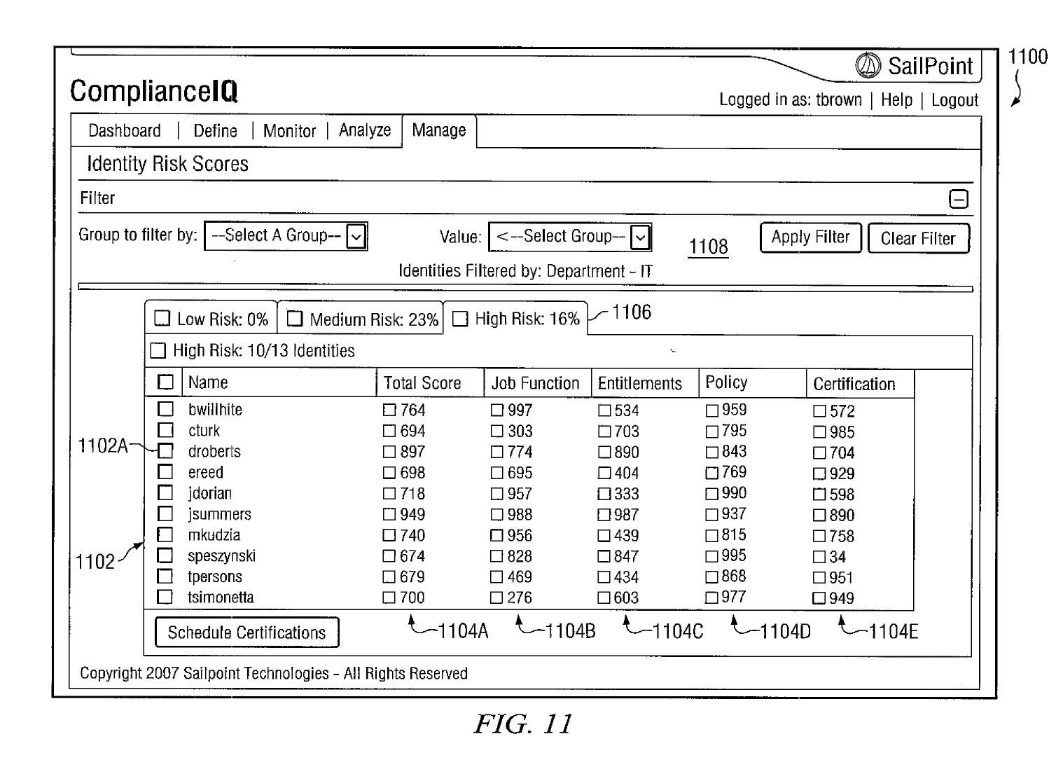

In some embodiments, users can click on pie chart sectors 1006 or bar segments 1010 to query information underlying the selected sector or bar segment. In one scenario, a user can select IT Department bar 1008D. Dashboard module 902 can display screen 1100 of FIG. 11 which can show access risk related data regarding users 1102 associated with the selected sector 1006 or bar segment 1010. Screen 1100 can illustrate composite access risk score 1104A, job function BAR subcomponent 1104B, entitlements BAR subcomponent 1004C, SOD policy BAR subcomponent 1104D, certification compensating factor 1104E, etc. Screen 1100 can include various navigation aids such as tabs 1106 allowing the user to access other data similar to that shown in FIG. 11. FIG. 11 shows that screen 1100 can include features 1108 for filtering, analyzing, sorting, etc. displayed access risk related data 1104A-E.

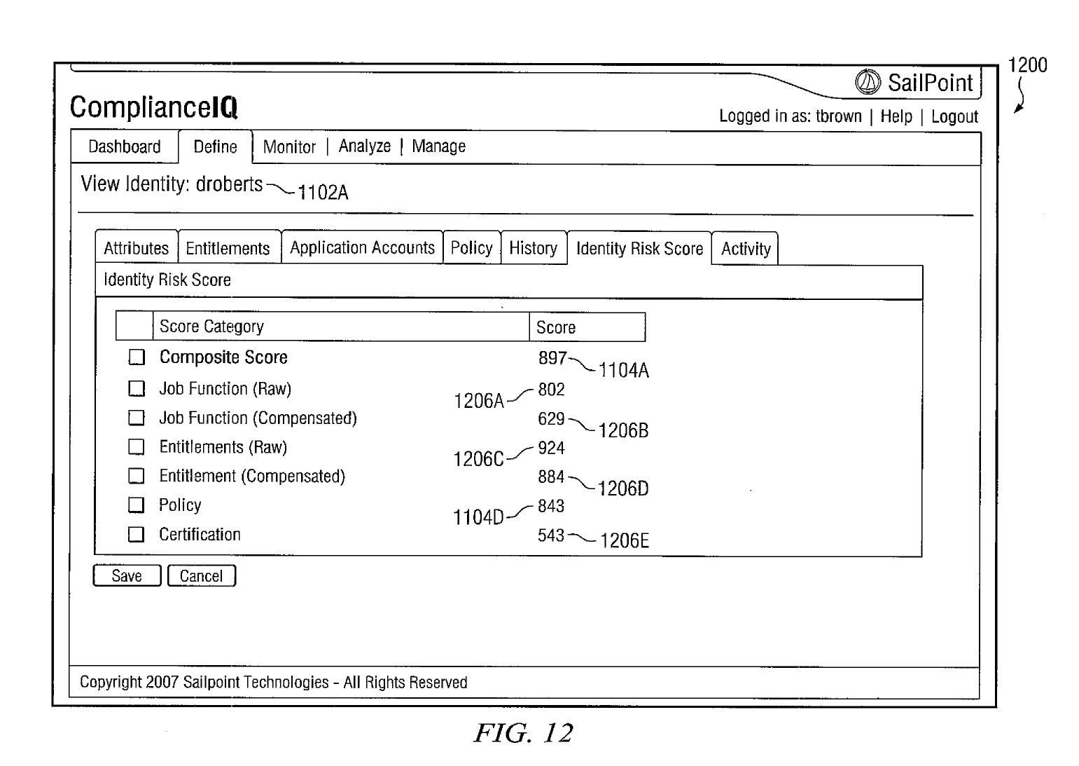

Screen 1100 can allow users to query for more detailed information regarding particular users 1102A or various BAR subcomponents 1104A-E. In one scenario, a user can select user 1102A “droberts” and dashboard module 902 (of FIG. 9) can respond by displaying screen 1200 which can display more detailed information regarding user 1102A. Screen 1200 can display users access risk data associated with user 1102A and enables users to understand uncompensated BAR subcomponents 1104, compensated BAR subcomponents 1106, etc. which might be contributing to a particular user's compensated access risk score. FIG. 12 shows user's 1102A composite access risk score 1104A of 897, uncompensated role (job function) BAR score 1206A of 802, compensated role BAR score 1206B of 629, uncompensated (extra) entitlement BAR score 1206C of 924, compensated extra entitlement BAR score 1206D of 884, policy violation BAR score 1104D of 843, and certification BAR score 1206E of 543. As illustrated, policy violation BAR score 1104D indicates that user 1102A may be associated with one or more policy violations. Certification BAR score 1206E of user 1102A indicates that one or more certifications associated with user 1102A may have aged beyond a user selected threshold.

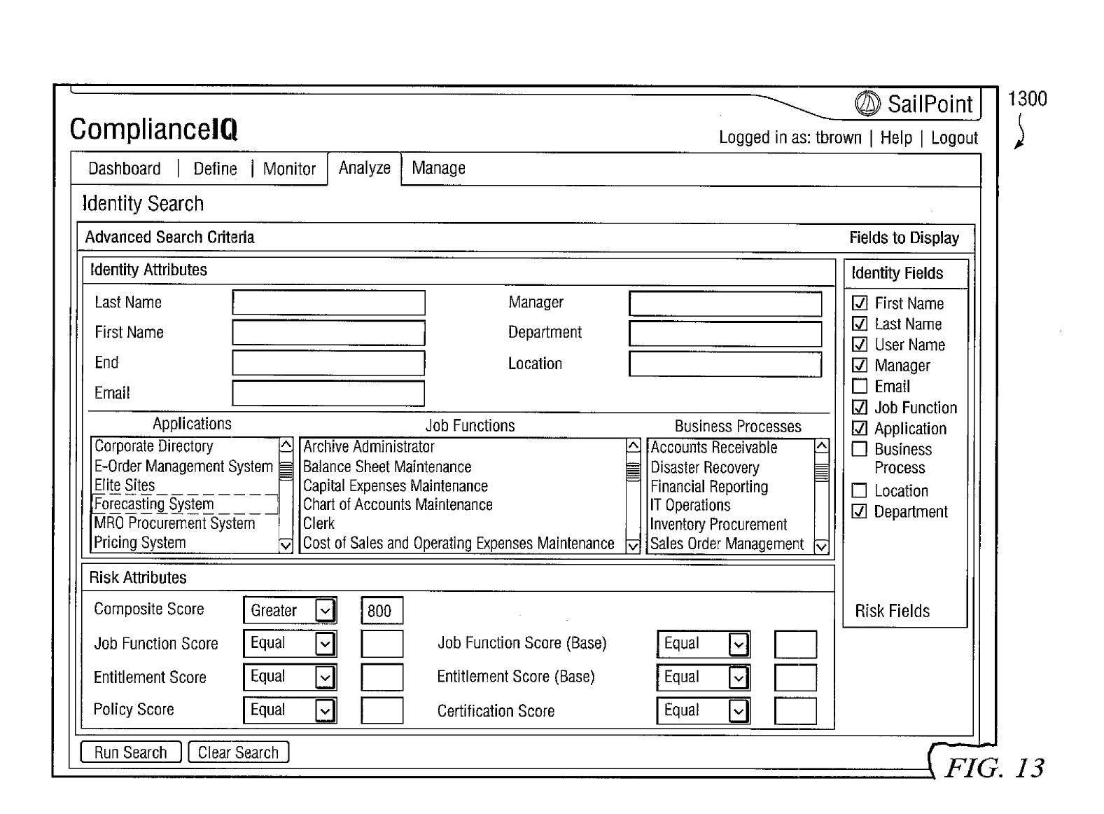

Various embodiments offer reporting and ad hoc query tools that enable users to search detailed access risk data and report on access risk trends, statistics, source data, etc. As shown by screen 1300 of FIG. 13, queried (access risk) data can be filtered by a variety of parameters, including by application, job function, and business process. FIG. 13 illustrates that screen 1300 allows users to compose simple or complex searches to identify users or groups of users by their BAR scores, compensating factors, subcomponents thereof, etc.

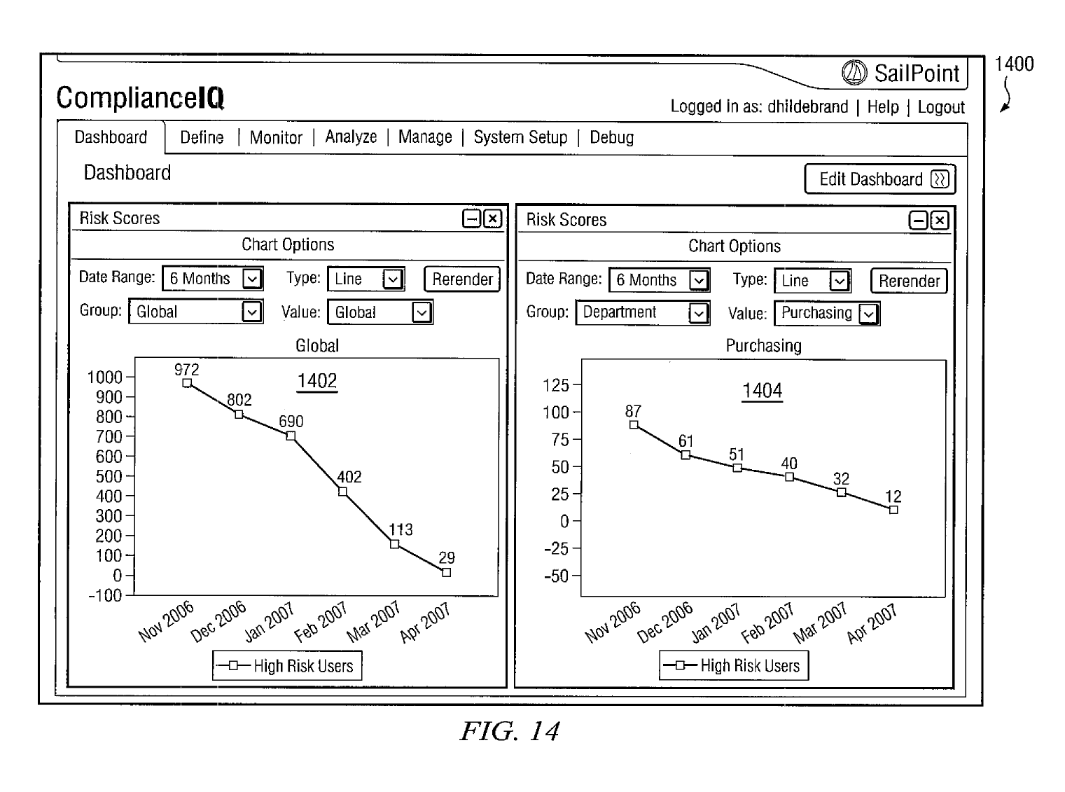

FIG. 14 illustrates trending capabilities of dashboard module 902 (of FIG. 9) of some embodiments. Screen 1400 of FIG. 14 can display one or more trend graphs 1402 and 1404. In one scenario, graph 1402 shows enterprise wide high-access risk data for a six-month period with graph 1404 showing a particular department's high-access risk data for the same six-month period.

### Access Risk Model

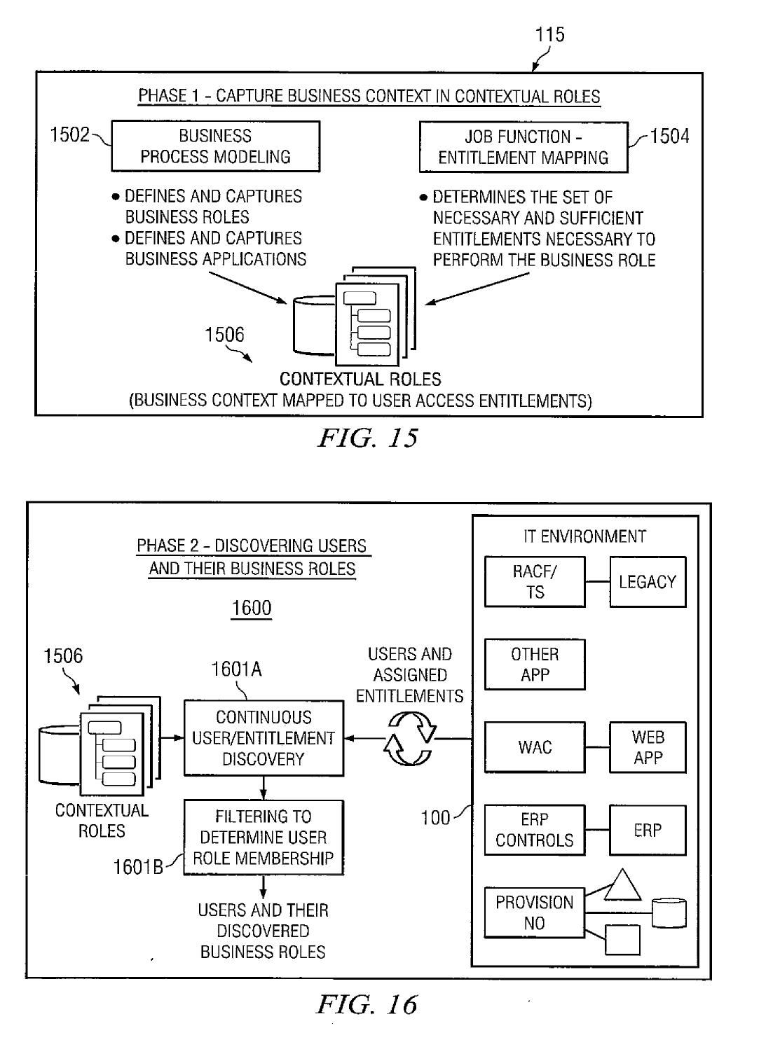

With reference now to FIGS. 15 and 16, access risk model 115 can characterize processes, users, roles, resources, entitlements, BAR scores, CARF scores, CARS scores, relationships between the same, etc. Access risk model can include tables containing information regarding various processes, users, roles, resources, entitlements, BAR scores, CARF scores, and CARS scores. The information in the tables can be determined via method 300 of FIG. 3. Access risk model 115 can be a relational database in which the tables are joined or linked to reflect various relationships between information in the tables. Access risk model 115 can determine BAR, CARF, and CARS scores.

As shown in FIG. 15 in some embodiments, access risk model 115 can reflect users, roles, resources, entitlements, etc. within the context of the business, or activity, in which enterprise 100 might be engaged. Process modeling module 1502 can determine the roles associated with resources of interest such as one or more resources 102. Roles can be associated with roles which users perform for enterprise 100 as part of various processes. For each role, enterprise 100 can determine sets of entitlements desirable for supporting various roles. A particular entitlement can enable a user to perform certain actions with a particular resource 102. Some entitlements can be permissions associated with the particular user 111 and used by enterprise 100 to grant access to a particular resource 102. In some embodiments, enterprise 100 may grant access to various resources 102 based on attributes associated with users 111. In one scenario, an attribute such as being a member of a particular group can cause enterprise 100 to grant access to a particular resource 102. Thus, being a member of that group, or in general having an attribute, can be modeled as raising access risk. Role and entitlement mapping module 1504 can assemble representations of these resources, roles, entitlements, attributes, etc. in such a way as to map entitlements and roles into the context of enterprise 100. These mapped roles and entitlement sets can be termed “contextual roles” 1506.

With reference to FIG. 16, FIG. 16 illustrates module 1600A of access risk model 115 of some embodiments. Module 1600A can include a reflection of enterprise 100 and its IT environment. Module 1600A can also include definitions of contextual roles 1502 (of FIG. 15) user discovery module 1601A, and role filtering module 1601B. User discovery module 1701A can continuously search enterprise 100 for new, modified, or deleted users and determine their sets of entitlements, attributes, etc. Using contextual roles 1602, role filtering module 1601B can determine (from the entitlement and attribute sets) which actual state roles various users 111 are observed to hold. The users 111 and their roles, entitlements, attributes, etc, can be output for storage, reporting, or further processing. Module 1600A can also determine compensating factors corresponding to various entitlements, apply those factors to access risk assessments, and generates access risk assessments for various users 111 and groups of users.

Various embodiments provide solutions to the problems associated with determining access risk in an organization such as enterprise 100. In some embodiments, solutions include systems and methods for quantifying various types of access risk that can be spread across various resources. In some embodiments, systems and methods utilize data related to user access mined from resources. Various embodiments mine data related to predefined access risk factors and compile multi-dimensional access risk scores based on the mined data. Mined data may be copied from the management stack (or layers thereof such as WAC (web access control) and SIEM (Security Information Event Manager) of various resources. In some embodiments, systems and methods provide information security and access risk management tools for identifying, evaluating, and responding to the access risks associated with user access to enterprise resources. In some embodiments, information security and access risk management tools include browser-based user interfaces through which users can define access risk models. In many embodiments, these tools can run on J2EE platforms. Those skilled in the art will recognize that many other embodiments are possible and within the scope of the disclosure.

Various embodiments implement methods for measuring access risk associated with resources of enterprise 100. Methods of some embodiments can model the enterprise, its systems, applications, programs, data, etc. to define roles and access entitlements associated with those roles. A user discovery engine can collect entitlement information from enterprises 100 in accordance with various embodiments. An entitlement correlation engine of some embodiments can compare the collected entitlement information against sets of entitlements associated with known roles to determine the roles that users currently hold. These sets of entitlements associated with known roles can be termed “entitlement filters.” The entitlement filters along with their corresponding roles can be termed “contextual roles” in some embodiments. Methods of some embodiments can assign access risk scores to the entitlements and can combine access risk scores of the entitlements for each user to measure the overall access risk associated with the individual users.

Access certifications, of some embodiments, enable automated, semi-automated, or manual reviews of access entitlements by person or persons within the enterprise. Access certifications can be performed by a user's direct manager or by the resource owner for which access is sought or by various systems discussed herein. In various embodiments, access certification can attest to the correctness of the user's or users' access to resources at the time of certification. Access certifications can also be used to certify that a user's access entitlements which violate enterprise policies can be allowed despite the violation. During access certifications, user entitlements and policy violations can be approved, or exceptions can be allowed, to permit particular access entitlements or policy exemptions for a specific time period. However, because access certifications attest to the correctness of access entitlements, and those entitlements change over time, access certifications age as time passes. Even though a system or application may have been certified some time ago, that certification becomes increasingly less meaningful as the certification ages.

Because users have access to resources the possibility arises that one, or more users may negligently or maliciously misappropriate, misuse, damage, sabotage, etc. some of the resources. In some scenarios, a user may have access to more, or more powerful, resources than warranted by that particular user's roles or functions in enterprise 100. In some scenarios, a particular user might have access to two resources which for policy reasons should not be accessed by the same user. These scenarios, and many others, create the risk that by accessing a resource, a particular user might use that resource improperly thereby causing damage to the enterprise.

In methods according to various embodiments, users such as business process owners, application owners, compliance officers, security officers, chief security officers, auditors, etc. may log in to one or more tools to define access risk models. These access risk models can provide for the access risk scoring disclosed herein. In many embodiments, defining these access risk models may include combinations of identifying potentially risky business processes in enterprise 100; defining business roles and job functions of users involved in the processes; defining access attributes and entitlements; assigning weights to the roles, job functions, attributes, and entitlements; modeling access related policy rules; and assigning weights to those rules. Access risk models of some embodiments can assess and track access risk with respect to user selected IT roles such as chief information officers, chief technical officers, business unit IT managers, IT auditors, IT compliance personnel, IT project managers, customer service representatives, etc. and user selected groups thereof. In various embodiments, defining the access risk models may further include identifying potentially sensitive resources such as systems, applications, data, etc. and obtaining information on users with access entitlements thereto. In some embodiments, user information can be obtained by dynamically discovering and mapping access related data. Other methods of obtaining desired user information such as manual entry are also envisioned and are within the scope of various embodiments.

In some embodiments, systems and methods operate to calculate baseline access risk (BAR) scores for users of various resources. BAR scores can be based on the users' business roles, job functions, responsibilities, duties, and the like and associated attributes, entitlements, and extra entitlements (which do not align with the users' business roles) held by users. BAR scores can be based on detectable violations of access policies by a user, such as separation of duty (SOD) rules. In some embodiments, access risk for applications and other IT resources can be quantified based on orphaned accounts, privileged user accounts, high access risk users, activity policy violations such as access which occurs outside of business hours, remote access, etc. BAR scores can represent un-moderated access risk scores without adjustments for controlling influences imposed upon the access risk sources.

In some embodiments, systems and methods operate to apply compensating factors that can influence BAR scores. Some compensating factors can either reduce or increase BAR scores. Various compensating factors can correspond to compensating controls implemented to influence the access risk underlying the BAR scores. Compensating controls can relate to, but are not limited to: whether a business role has been certified during an access certification; whether a policy exception has been allowed or has expired; whether a remedial action to remove an entitlement has been requested but not performed; whether an entitlement persists or recurs that has been disassociated with a user, and combinations of any of the above. Other compensating controls are also possible and can be readily configured or otherwise implemented in various embodiments. Compensating factors corresponding to compensating controls detected by models of some embodiments can be combined with BAR scores to form composite access risk (CARS) scores for various users. The formulation of CARS scores can be customized or otherwise configurable. Weighting factors may be associated with BAR scores and compensating factors. In some embodiments, CARS scores for individual users can be utilized to generate rolled-up access risk profiles at levels above individual users such as levels corresponding to groups of users, departments, divisions, etc.

Many factors affecting an organization's access risk can be quantified using data mined from applications, resources, systems, and other aspects of IT environments. Access logs, user entitlement lists, system administrator lists, etc. can be mined for data to quantify enterprise 100's access risk. By normalizing and analyzing this data against defined policies and other factors, embodiments can enable business entities, institutions, organizations, and the like to quantify access risk, compile access risk profiles at various levels (e.g., individual, group, department, division, geographic, corporate/enterprise, etc.), track changes in access risk, and perform trend analyses. Some embodiments implement methods in which certain identity attributes can be designated as having a particular influence on access risk. In one scenario, particular identity attributes (such as one indicating that a user accesses resources while located in another geolocation) can indicate that a particular access risk might be associated therewith.

Access risk management, in accordance with various embodiments, can help ensure regulatory compliance in a cost effective manner while also meeting appropriate standards related to enterprise governance. Various embodiments provide solutions which combine automated access risk analytics with automated monitoring and controls thereby allowing organizations to analyze, manage, mitigate, etc. access risk with visibility into various access risk metrics. In accordance with some embodiments, organizations can focus their access risk management efforts strategically, track progress over time, and provide quantifiable proof of enhanced security and reduced access risk.

Various embodiments provide insights into access risk that enable organizations to track, analyze, and control user access to enterprise resources. Some embodiments help organizations assess their access risk, prioritize security efforts, and take remedial action regarding their access risk. Central access risk management systems provided by various embodiments can break down departmental silos, thereby allowing organizations to analyze overall access risk and implement effective enterprise level controls to satisfy regulatory mandates.

Although embodiments have been described in detail herein, it should be understood that the description is by way of example only and is not to be construed in a limiting sense. It is to be further understood, therefore, that numerous changes in the details of the embodiments and additional embodiments will be apparent, and may be made by, persons of ordinary skill in the art having reference to this description. It is contemplated that all such changes and additional embodiments are within scope of the claims below and their legal equivalents.

What is claimed is:

1. A method for measuring access risk associated with an enterprise having at least one resource accessible by at least one user with at least one entitlement to access the resource, the method comprising:
identifying the resources;
identifying the users of the resources;
identifying the entitlements associated with each of the users;
associating an access risk score with each of the entitlements; and
for each user, combining the access risk scores associated with the user to form a composite access risk score; and
outputting the composite access risk scores for each of the users.

2. The method of claim 1 further comprising using the composite access risk scores to identify the user with a highest access risk score.

3. The method of claim 2 wherein the highest access risk user is selected from a group consisting of a department, a division, a subsidiary, and an organization.

4. The method of claim 2 further comprising taking a remedial action with respect to the highest access risk user.

5. The method of claim 1 wherein the identifying the entitlements and the combining the access risk scores occurs in real time wherein a system administrator is alerted to a change in the entitlements.

6. The method of claim 1 further comprising adjusting at least one access risk score based on a compensating factor.

7. The method of claim 1 further comprising adjusting at least one access risk score based on a compensating control on at least one entitlement.

8. The method of claim 1 further comprising adjusting at least one combined access risk score associated with a user based on a combination of personal factors.

9. The method of claim 8 wherein the personal access risk factors including one or more of geographic location, weather, demographic characteristics of the user, behavior, personal history, a previous entitlement the user had, a previous role the user had, or an entitlement that has been disassociated with the user and that recurs.

10. An enterprise system comprising:
at least one resource with access points for at least one user;
a processor in communication with the resources;
an output in communication with the processor; and
a machine readable memory in communication with the processor and for storing instructions which when executed cause the machine to:
identify the resources;
identify the users of the resources;
identify the entitlements associated with each of the users;
associate an access risk score with each of the entitlements; and
for each user, combine the access risk scores associated with the user to form a composite access risk score; and
output the composite access risk scores for each of the users at the output.

11. The system of claim 10 wherein the instructions further cause the machine to use the composite access risk scores to identify the user with a highest access risk score.

12. The system of claim 11 wherein the highest access risk user is selected from a group consisting of a department, a division, a subsidiary, and an organization.

13. The system of claim 11 wherein the instructions further cause the machine to alert a system administrator to take a remedial action with respect to the highest access risk user.

14. The system of claim 10 wherein the identification of the entitlements and the combining of the access risk scores occurs in real time wherein a system administrator is alerted to a change in the entitlements.

15. The system of claim 10 wherein the instructions further cause the machine to adjust at least one access risk score based on a compensating factor.

16. The system of claim 10 wherein the instructions further cause the machine to adjust at least one access risk score based on a compensating control on at least one entitlement.

17. The system of claim 10 wherein the instructions further cause the machine to adjust at least one combined access risk score associated with a user based on a combination of personal factors.

18. The system of claim 17 wherein the personal access risk factors including one or more of geographic location, weather, demographic characteristics of the user, behavior, personal history, a previous entitlement the user had, a previous role the user had, or an entitlement that has been disassociated with the user and that recurs.

19. A computer readable medium carrying machine readable instructions which when executed cause the machine to:
identify the resources of an enterprise;
identify the users of the resources;
identify the entitlements associated with each of the users;
associate an access risk score with each of the entitlements; and
for each user, combine the access risk scores associated with the user to form a composite access risk score; and
output the composite access risk scores for each of the users at an output of one of the systems.

20. The computer readable medium of claim 19 wherein the instructions are further executable to cause the machine to alert a system administrator to a change in the entitlements, the highest access risk user, or both in real time.
